(19) United States
(12) Patent Application Publication
(10) Pub. No.: US 2009/0051971 A1
(43) Pub. Date: Feb. 26, 2009

(54) APPARATUS AND METHOD FOR IMAGE RECORDING, APPARATUS AND METHOD FOR IMAGE MANAGEMENT, PHOTO ALBUM, AND PROGRAMS

(76) Inventor: Koji Nakamura, Tokyo (JP)

Correspondence Address: BIRCH STEWART KOLASCH & BIRCH, PO BOX 747, FALLS CHURCH, VA, 22040-0747, US

(21) Appl. No.: 12/282,151

(22) PCT Filed: Mar. 8, 2007
(86) PCT No.: PCT/JP2007/055149

§ 371 Date: Sep. 8, 2008

(30) Foreign Application Priority Data
Mar. 9, 2006 (JP) 2006-063830

(51) Int. Cl. G06K 15/00

(52) U.S. Cl. 358/1.18

(57) ABSTRACT

An image recording apparatus is configured to comprise identification information reading means for reading identification information from a photo album having a communication device storing the identification information identifying the photo album that contains print storage units wherein index prints having a plurality of images laid out in a predetermined layout can be stored and a recording medium storage unit wherein a recording medium storing the images is stored, and recording means for recording all the images laid out in the index prints in the recording medium, by relating the images to the identification information.

### TECHNICAL FIELD

The present invention relates to an apparatus and a method for recording images in a recording medium such as a CD or DVD, to an apparatus and a method for storing images, and to a photo album that stores index prints having a plurality of images laid out therein. The present invention also relates to programs that cause a computer to execute the methods.

### BACKGROUND ART

Printing services for printing images obtained by digital cameras are currently being provided. In such printing services, printing is carried out in the following manner. Each user firstly specifies images to be printed by using viewer software installed in his/her personal computer, and generates order information representing the content of an order such as quantities and print sizes. The user then records the order information in a recording medium such as a memory card together with the images to be printed, and brings the recording medium to a DPE store. The user sets the recording medium in an order reception apparatus installed in the DPE store, and operates the apparatus according to instructions displayed on a screen. The images are then printed by a printer of the DPE store, according to the content of the order represented by the order information.

By placing an order to record the images stored in the recording medium in a CD, the user can back up the images. In this case, an index print may be generated, wherein a catalog of all the images stored in the recording medium is laid out. By referring to the index print, the user can confirm the images recorded in the CD at a glance.

Meanwhile, a method has been proposed in Japanese Unexamined Patent Publication No. 2005-56030 for printing images on recording materials embedded with communication devices such as small non-contact IC memory tags that enable wireless communication (hereinafter referred to as IC tags). In this method, identification information for identifying the recording materials is stored in the IC tags, and image data representing the printed images are stored by being related to the identification information. Therefore, by reading the identification information from the prints added with the IC tags, the image data corresponding to the identification information can be read. As a result, an index print wherein the images represented by the image data are laid out can be generated, and a slide show using the image data can be played back.

However, in the method described in Japanese Unexamined Patent Publication No. 2005-56030, the IC tags need to be added to the respective prints. Therefore, printing becomes costly if the number of images is large. In addition, since the prints are often stored in a photo album, the prints need to be removed from the album to read the identification information thereof. Consequently, operations for using the images such as generation of an index print are troublesome in this method.

The present invention has been conceived based on consideration of the above circumstances, and an object of the present invention is to enable easy use of images.

### DISCLOSURE OF THE INVENTION

An image recording apparatus of the present invention comprises:

identification information reading means for reading identification information from a photo album that contains print storage units wherein index prints having a plurality of images laid out in a predetermined layout can be stored and a recording medium storage unit wherein a recording medium storing the images is stored, the photo album having a communication device storing the identification information that identifies the photo album; and

recording means for recording all the images laid out in the index prints in the recording medium, by relating the images to the identification information.

The communication device refers to a non-contact IC memory tag that enables non-contact communication, for example. The communication device enables information reading and writing in a non-contact manner by a tag reader that carries out wireless communication with the communication device.

In the image recording apparatus of the present invention, the recording means may record layout information representing the predetermined layout in the recording medium, by relating the layout information to the identification information.

A first image management apparatus of the present invention comprises:

reading means for reading the images and the identification information from the recording medium in which the image recording apparatus of the present invention has recorded the images and the identification information;

storage means for storing therein the images read from the recording medium, by relating the images to the identification information;

identification information reading means for reading the identification information from the communication device of the photo album;

search means for searching the storage means for the images corresponding to the identification information; and

playback means for playing back the images found through the search.

A second image management apparatus of the present invention comprises:

reading means for reading the images, the identification information, and the layout information from the recording medium in which the image recording apparatus of the present invention has recorded the images, the identification information, and the layout information;

storage means for storing therein the images and the layout information read from the recording medium, by relating the images and the layout information to the identification information;

identification information reading means for reading the identification information from the communication device of the photo album;

search means for searching the storage means for the images and the layout information corresponding to the identification information; and

playback means for playing back the images found through the search by laying out the images according to the layout information found through the search.

A photo album of the present invention is a photo album containing print storage units wherein index prints having a plurality of images laid out in a predetermined layout can be stored and a recording medium storage unit wherein a recording medium storing the images is stored, and the photo album comprises a communication device storing identification information that identifies the photo album.

An image recording method of the present invention comprises the steps of:

reading identification information from a photo album containing print storage units wherein index prints having a plurality of images laid out in a predetermined layout can be stored and a recording medium storage unit wherein a recording medium storing the images is stored, the photo album having a communication device storing the identification information that identifies the photo album; and

recording all the images laid out in the index prints in the recording medium, by relating the images to the identification information.

The image recording method of the present invention may further comprise the step of recording layout information representing the predetermined layout in the recording medium, by relating the layout information to the identification information.

A first image management method of the present invention comprises the steps of:

reading the images and the identification information from the recording medium in which the images and the identification information have been recorded according to the image recording method of the present invention;

storing the images read from the recording medium, by relating the images to the identification information;

reading the identification information from the communication device of the photo album;

searching the storage means for the images corresponding to the identification information; and

playing back the images found through the search.

A second image management method of the present invention comprises the steps of:

reading the images, the identification information, and the layout information from the recording medium in which the images, the identification information, and the layout information have been recorded according to the image recording method of the present invention;

storing the images and the layout information read from the recording medium, by relating the images and the layout information to the identification information;

reading the identification information from the communication device of the photo album;

searching the storage means for the images and the layout information corresponding to the identification information; and

playing back the images found through the search by laying out the images according to the layout information found through the search.

The image recording method and the first and second image management methods of the present invention may be provided as programs that cause a computer to execute the methods.

According to the image recording apparatus and the image recording method of the present invention, the identification information is read from the photo album having the communication device storing the identification information that identifies the photo album, and all the images laid out in the index prints are recorded in the recording medium by being related to the identification information. Therefore, the photo album storing the index prints can be easily related to the images laid out in the index prints stored in the photo album.

By recording the layout information representing the layout of the index prints in the recording medium while relating the layout information to the identification information, the photo album storing the index prints can be easily related to the images laid out in the index prints therein and to the layout of the index prints.

According to the first image management apparatus and the first image management method of the present invention, the images and the identification information are read from the recording medium storing all the images laid out in the index prints and the identification information related thereto, and the images are stored by being related to the identification information. The identification information is read from the communication device of the photo album, and the images corresponding to the identification information are searched for. The images are then played back. Therefore, the images can be played back by only reading the identification information once. Consequently, the images can be used easily.

According to the second image management apparatus and the second image management method of the present invention, all the images laid out in the index prints, the identification information, and the layout information are read from the recording medium that stores the images, the layout information, and the identification information related thereto. The images and the layout information are then stored by being related to the identification information. The identification information is read from the communication device of the photo album, and the images corresponding to the identification information are searched for. The images are then played hack by being laid out according to the layout information found through the search. Therefore, the images can be played back in the layout corresponding to the index prints by only reading the identification information once. Consequently, the images can be used easily.

### BRIEF DESCRIPTION OF THE DRAWINGS

FIG. 1 is a perspective view of the exterior of an order reception apparatus adopting an image recording apparatus of an embodiment of the present invention;

FIG. 2 is a block diagram showing the configuration of the order reception apparatus in the embodiment;

FIG. 3 shows an example of an index print;

FIG. 4 shows another example of the index print;

FIGS. 5A to 5C show a photo album;

FIG. 6 is a flow chart showing procedures carried out by the order reception apparatus in the embodiment;

FIG. 7 is a block diagram showing the configuration of an image management apparatus of an embodiment of the present invention;

FIG. 8 is a flow chart showing procedures carried out by the image management apparatus in the embodiment; and

FIG. 9 shows a screen in which layout images are displayed.

### BEST MODE FOR CARRYING OUT THE INVENTION

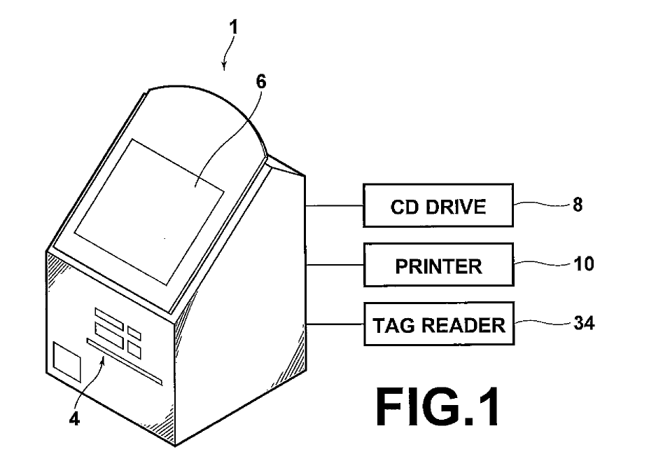

Hereinafter, embodiments of the present invention will be described with reference to the accompanying drawings. FIG. 1 is a perspective view of the exterior of an order reception apparatus that receives orders of prints and the like and adopts an image recording apparatus of the present invention. As shown in FIG. 1, an order reception apparatus 1 in this embodiment is installed in a DPE store and receives orders placed by users to record images in a CD, to print images, and the like. The order reception apparatus 1 has various kinds of card slots 4 wherein various kinds of memory cards 2 recorded with images are inserted to read images from the cards 2 and to write images therein. The order reception apparatus 1 also has a display unit 6 for carrying out various kinds of display for ordering, and is connected to a CD drive 8 and to a printer 10 installed in the DPE store. The display unit 6 has a touch-panel input unit. Therefore, the user can carry out input necessary for ordering, by touching the display unit 6 according to the display shown on the display unit 6. The order reception apparatus 1 is also connected to a tag reader 34 that will be described later.

In this embodiment, when the user places the order for recording images of the user stored in his/her memory card 2 (hereinafter referred to as user images) in a CD, the DPE store provides a service of printing index prints on which thumbnails of the user images recorded in the CD are laid out and of furnishing to the user a photo album that stores the CD and the index prints.

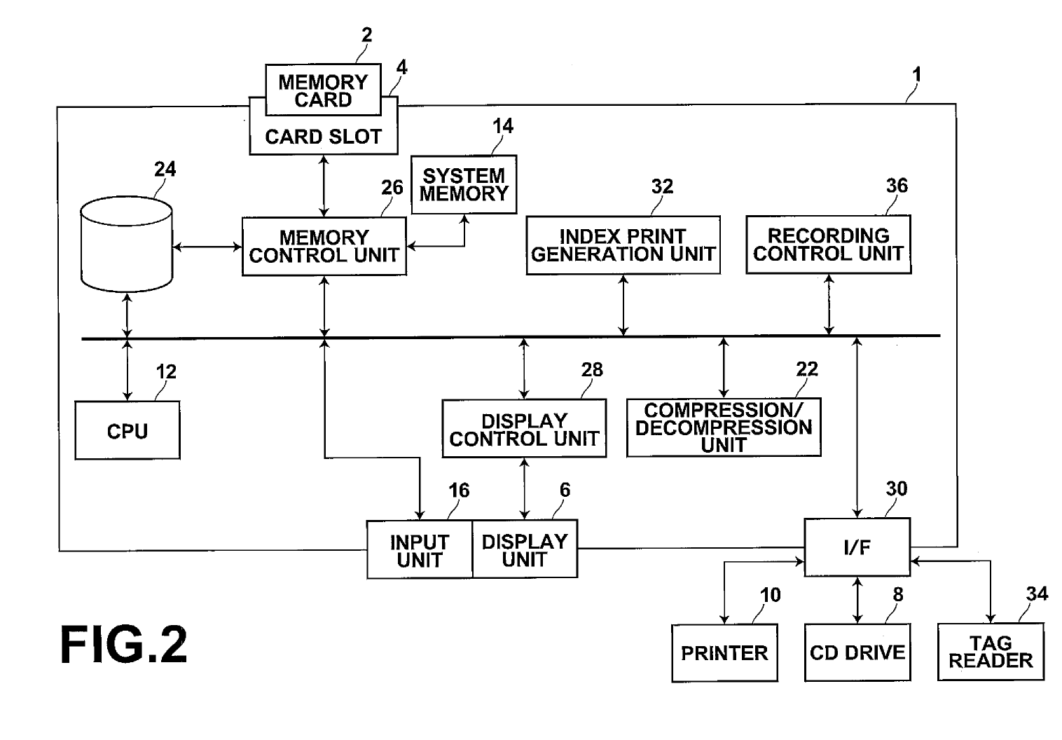

FIG. 2 is a block diagram showing the configuration of the order reception apparatus in the embodiment of the present invention. As shown in FIG. 2, the order reception apparatus 1 comprises a CPU 12, a system memory 14, an input unit 16, together with the display unit 6. The CPU 12 carries out various kinds of control such as recording control and display control of image data representing images, and controls each unit comprising the apparatus 1. The system memory 14 has a ROM that stores a basic program for operating the apparatus 1 and various kinds of constants. The system memory 14 also has a RAM used as workspace for processing by the CPU 12. The input unit 16 is a touch-panel input unit, and used to input various kinds of instructions to the apparatus 1.

The order reception apparatus 1 also has a compression/decompression unit 22, a hard disc 24, a memory control unit 26, a display control unit 28, and an interface (I/F) 30, in addition to the card slots 4. The compression/decompression unit 22 carries out image data compression according to a format such as JPEG, and decompresses compressed image data. The hard disc 24 stores various kinds of programs executed by the CPU 12 such as an ordering program for recording the images represented by image data read from the memory cards 2. The memory control unit 26 controls the system memory 14, the card slots 4, and the hard disc 24. The display control unit 28 controls display on the display unit 6. The I/F 30 connects the CD drive 8 and the printer 10 to the apparatus 1.

Although the card slots 4 corresponding to various kinds of memory cards 2 are provided, only one of the card slots 4 is shown in FIG. 2.

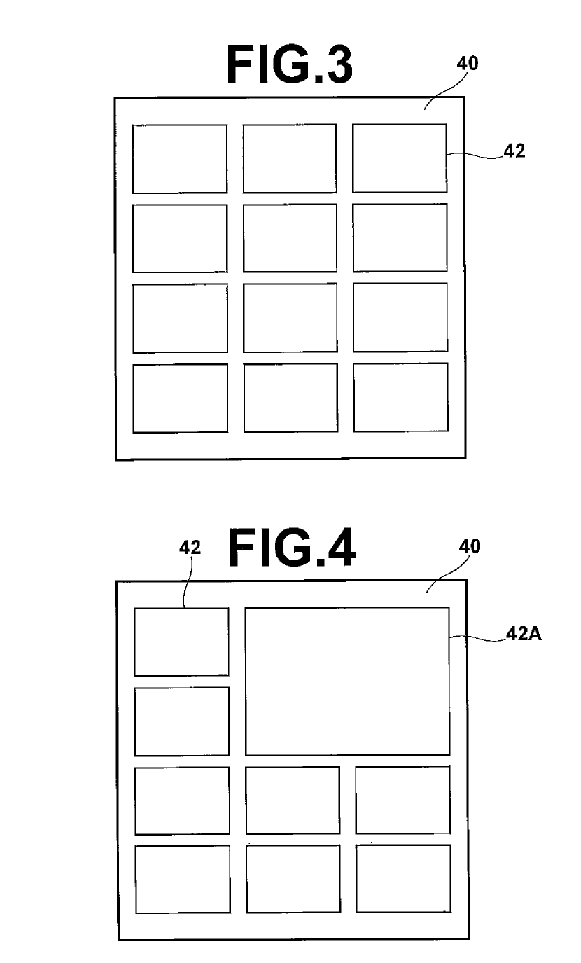

The order reception apparatus 1 also comprises an index print generation unit 32 that generates data for obtaining the index prints (hereinafter referred to as the index print data) by arranging the user images read from the memory card 2 according to file names or the like thereof. In this embodiment, a background image 40 used as a background of the index prints basically has 12 image insertion areas 42 of the same size wherein 12 of the user images can be laid out as shown in FIG. 3. However, as shown in FIG. 4, any four of the image insertion areas 42 (located in the upper right in the example shown in FIG. 4) may be combined together to form a large image insertion area 42A. Therefore, the index print data are generated by laying out every 9 of the user images in the background image 40. At the time of generation of the index print data, the index print generation unit 32 generates layout information representing the file names of the arranged user images, the file names of the enlarged user images, and positions of the user images.

The order reception apparatus 1 also has the tag reader 34 and a recording control unit 36. The tag reader 34 carries out non-contact reading of identification information that identifies the photo album, from an IC tag added to the photo album containing the index prints as will be described later. The recording control unit 36 controls the CD drive 8 so as to record in the CD the user images read from the memory card 2 and the layout information of the user images arranged in the index prints, by relating the user images and the layout information to the identification information. The tag reader 34 is connected to the interface 30, and used by a clerk at the DPE store.

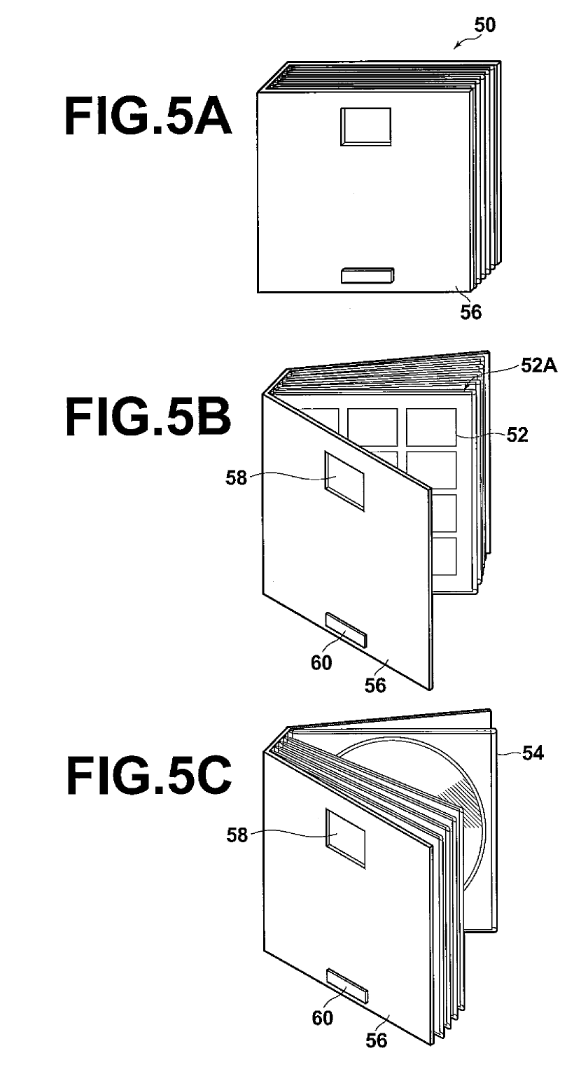

FIGS. 5A to 5C show the photo album in this embodiment. FIG. 5A shows a state wherein the photo album is closed while FIGS. 5B and 5C respectively show states wherein the photo album is open to show print storage units and a CD storage unit that will be described later. A photo album 50 in this embodiment shown in FIGS. 5A to 5C comprises bag-like print storage units 52 made of a transparent material having a rectangular shape corresponding to the index prints so as to contain the index prints, and a bag-like CD storage unit 54 that stores the CD having the user images recorded therein. A book cover 56 of the photo album 50 covers the print storage units 52 and the CD storage unit 54. The index prints are slipped in to the print storage units 52 from openings 52A of the print storage units 52.

The book cover 56 has a window 58 having a representative image of the user images recorded in the CD. A non-contact IC tag 60 storing the identification information of the photo album 50 is added to the book cover 56, by being pasted thereon, for example.

Hereinafter, the functions of the tag reader 34 and the recording control unit 36 will be described together with procedures carried out by the order reception apparatus 1.

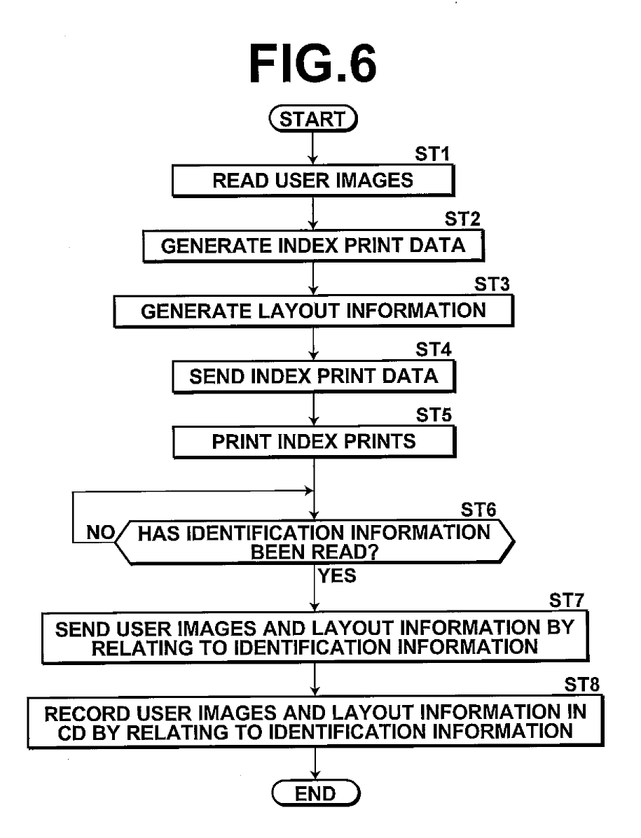

FIG. 6 is a flow chart showing the procedures carried out by the order reception apparatus 1 in this embodiment. The CPU 12 starts processing when the user inserts the memory card 2 into a corresponding one of the card slots 4 and inputs from the input unit 16 an instruction to order recording of the user images of the memory card 2 in the CD. The CPU 12 reads the user images stored in the memory card 2 (Step ST1), and the index print generation unit 32 generates the index print data by arranging the user images in the background image 40 as has been described above (Step ST2) . The index print generation unit 32 further generates the layout information representing the layout of the images in the index print data (Step ST3). The layout information is temporarily stored in the hard disc 24.

The index print generation unit 32 then sends the index print data to the printer 10 (Step ST4) . The printer 10 prints the index prints wherein the thumbnails of the user images are arranged in order of the file names thereof (Step ST5).

The clerk at the DPE store stores the index prints in the photo album, and then causes the tag reader 34 to read the identification information stored in the IC tag 60 of the photo album 50, by bringing the IC tag 60 close to the tag reader 34.

For this reason, the recording control unit 36 starts monitoring whether the identification information has been read from the IC tag 60 (Step ST6) . If a result at Step ST6 is affirmative, the recording control unit 36 sends the user images and the layout information to the CD drive 8 (Step ST7) by relating the user images and the layout information to the identification information. In response, the CD drive 8 records the user images and the layout information in the CD (Step ST8) by relating the images and the layout information to the identification information to end the procedures.

The clerk at the DPE store stores the CD having the user images in the CD storage unit 54 of the photo album 50, and provides the photo album to the user.

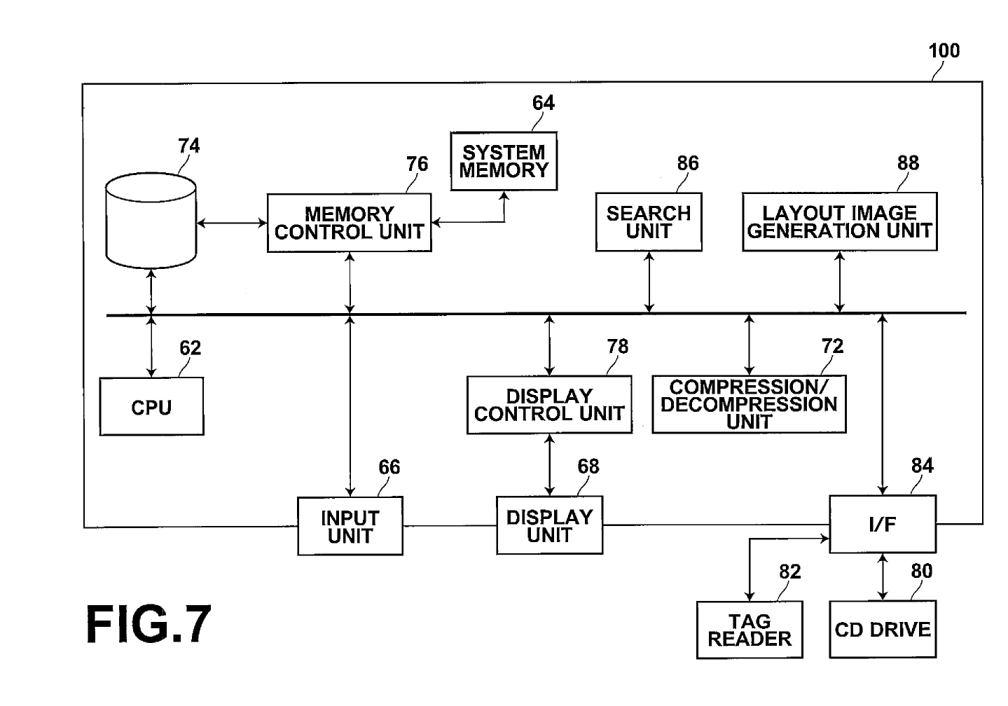

An image management apparatus of an embodiment of the present invention will be described next. FIG. 7 is a block diagram showing the configuration of an image management apparatus in the embodiment of the present invention. As shown in FIG. 7, an image management apparatus 100 in this embodiment is used by the user who received the photo album 50, and comprises a CPU 62, a system memory 64, an input unit 66, and a display unit 68. The CPU 62 carries out various kinds of control such as recording control and display control of image data representing images, and controls each unit comprising the apparatus 100. The system memory 64 has a ROM that stores a basic program for operating the apparatus 100 and various kinds of constants. The system memory 64 also has a RAM used as workspace for processing by the CPU 62. The input unit 66 comprises a keyboard and a mouse for inputting various kinds of instructions to the apparatus 100. The display unit 68 carries out various kinds of display.

The image management apparatus 100 also comprises a compression/decompression unit 72, a hard disc 74, a memory control unit 76, a display control unit 78, and an interface (I/F) 84. The compression/decompression unit 72 compresses image data according to a format such as JPEG, and decompresses compressed image data. The hard disc 74 stores various kinds of programs to be executed by the CPU 62 and the like. The memory control unit 76 controls the system memory 64 and the hard disc 74. The display control unit 78 controls display on the display unit 68. The interface 84 connects a CD drive 80 and a tag reader 82 to the apparatus 100. The tag reader 82 carries out non-contact reading of the identification of the photo album 50 from the IC tag 60 added to the photo album 50 storing the index prints, in the same manner as the tag reader 34 described above.

The image management apparatus 100 also has a search unit 86 for searching user images stored in the hard disc 74 for the user images corresponding to the identification information read from the IC tag 60 of the photo album 50 as will be described later, and a layout image generation unit 88 for generating layout images by laying out the user images as will be described later.

In this embodiment, the user has a plurality of the photo albums 50, and the image management apparatus 100 reads the user images, the layout information, and the identification information from each of the CDs storing the user images, by using the CD drive 80. The image management apparatus 100 stores the user images and the layout information in the hard disc 74 by relating the user images and the layout information to the identification information.

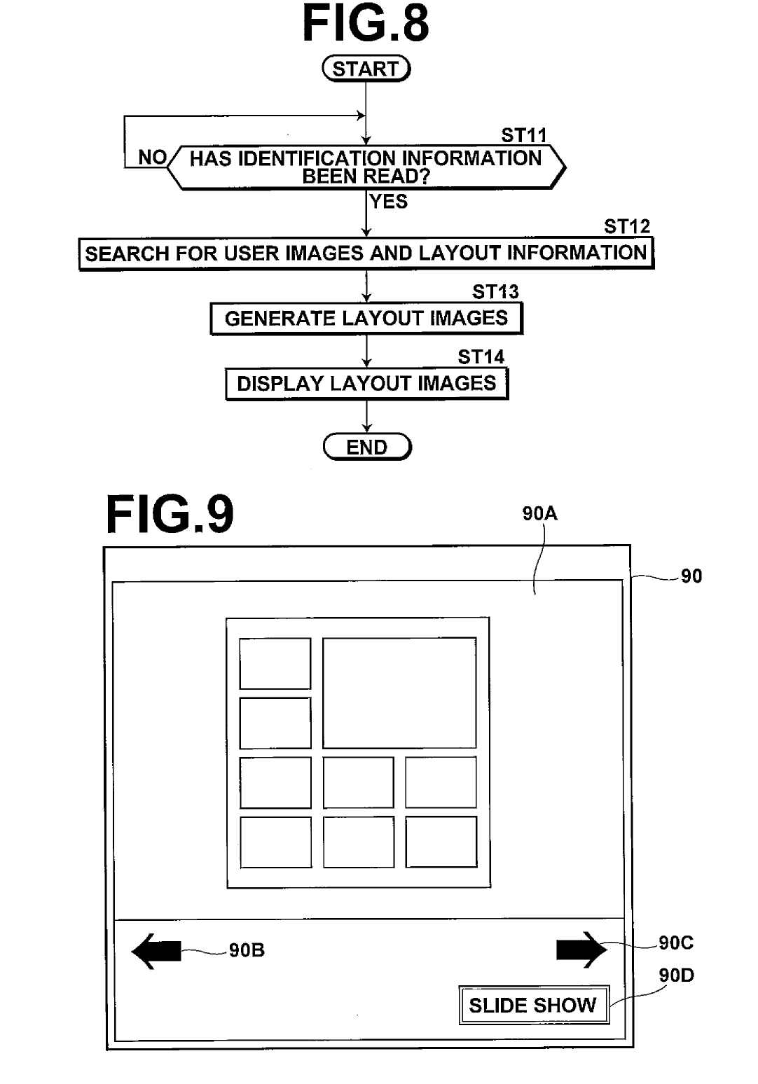

The procedures carried out in the image management apparatus 100 in this embodiment will be described below. FIG. 8 is a flow chart showing the procedures carried out by the image management apparatus 100. The CPU 62 starts processing when the user causes the tag reader 82 to read the IC tag 60 of a desired one of the photo albums 50. Therefore, the CPU 62 monitors whether the tag reader 82 has read the identification information (Step ST11). If a result at Step ST11 is affirmative, the search unit 86 searches for the user images and the layout information related to the identification information (Step ST12).

The layout image generation unit 88 generates the layout images by laying out the user images according to the layout information found through the search (Step ST13). The layout of the user images in the layout images is the same as in the index prints stored in the photo album 50 from which the identification information has been read. The layout image generation unit 88 displays the layout images on the display unit 68 (Step ST14) to end the procedures.

FIG. 9 shows a screen in which the layout images are displayed. As shown in FIG. 9, a display screen 90 of the layout images has an image display area 90A for displaying the layout images, buttons 90B and 90C for changing the layout image to be displayed in the image display area 90A, and a Slide Show button 90D for playing back a slide show.

The user can change the layout image to be displayed in the image display area 90A by using the buttons 90B and 90C1 as if turning a page of the photo album 50. The user can also play back the slide show of the user images by selecting the Slide Show button 90D.

As has been described above, according to the image recording apparatus in the embodiment, the identification information of the photo album 50 is read from the IC tag 60 of the photo album 50, and all the user images laid out in the index prints are recorded in the CD by being related to the identification information. Therefore, the photo album 50 storing the index prints can be easily related to the user images laid out in the index prints stored in the photo album 50.

By recording the layout information representing the layout of the index prints in the CD while relating the layout information to the identification information, the photo album 50 storing the index prints can be easily related to the user images laid out in the index prints in the photo album 50 and to the layout of the index prints.

According to the image management apparatus in the embodiment described above, the user images and the layout information of the index prints stored in the CD are saved by being related to the identification information stored in the IC tag 60 of the corresponding photo album 50, and the identification information is read from the IC tag 60 of the photo album 50. The user images and the layout information related to the identification information are then searched for, and the user images are laid out and played back. Therefore, the user images can be played back in the layout corresponding to the index prints by only reading the identification information once. Consequently, the user images can be used easily.

In the embodiment of the image recording apparatus, the layout information is stored in the CD. However, the layout information is not necessarily stored in the CD. In this case, the image management apparatus 100 searches for only the user images corresponding to the identification information, and the user images are played back as a catalog of the thumbnails or a slide show.

In the embodiments described above, the user images, the layout information, and the identification information are stored in the CD. However, a recording medium of another type, such as a DVD, may store the images and the information.

Although the embodiments related to the image recording apparatus and the image management apparatus of the present invention have been described above, programs that cause computers to function as means corresponding to the index print generation unit 32, the recording control unit 36, the search unit 86, and the layout image generation unit 88 and to carry out the procedures shown in FIGS. 6 and 8 are also embodiments of the present invention. Computer-readable recording media storing such programs are also embodiments of the present invention. In addition, such programs may be incorporated into viewer software for image viewing.

1-12. (canceled)

13. An image recording apparatus comprising:
identification information reading means for reading identification information from a photo album containing print storage units wherein index prints having a plurality of images laid out in a predetermined layout can be stored and a recording medium storage unit wherein a recording medium storing the images is stored, the photo album having a communication device storing the identification information identifying the photo album; and
recording means for recording all the images laid out in the index prints in the recording medium, by relating the images to the identification information.

14. The image recording apparatus according to claim 13 wherein the recording means records layout information representing the predetermined layout in the recording medium, by relating the layout information to the identification information.

15. An image management apparatus comprising:
reading means for reading the images and the identification information from the recording medium in which the image recording apparatus of claim 13 has recorded the images and the identification information;
storage means for storing therein the images read from the recording medium, by relating the images to the identification information;
identification information reading means for reading the identification information from the communication device of the photo album;
search means for searching for the images corresponding to the identification information; and
playback means for playing back the images found through the search.

16. An image management apparatus comprising:
reading means for reading the images, the identification information, and the layout information from the recording medium in which the image recording apparatus of claim 14 has recorded the images, the identification information, and the layout information;
storage means for storing therein the images and the layout information read from the recording medium, by relating the images and the layout information to the identification information;
identification information reading means for reading the identification information from the communication device of the photo album;
search means for searching for the images and the layout information corresponding to the identification information; and
playback means for playing back the images found through the search by laying out the images according to the layout information found through the search.

17. A photo album containing print storage units wherein index prints having a plurality of images laid out in a predetermined layout can be stored and a recording medium storage unit wherein a recording medium storing the images is stored, the photo album comprising:
a communication device storing identification information identifying the photo album.

18. An image recording method comprising the steps of:
reading identification information from a photo album containing print storage units wherein index prints having a plurality of images laid out in a predetermined layout can be stored and a recording medium storage unit wherein a recording medium storing the images is stored, the photo album having a communication device storing the identification information identifying the photo album; and
recording all the images laid out in the index prints in the recording medium, by relating the images to the identification information.

19. The image recording method according to claim 18 further comprising the step of recording layout information representing the predetermined layout in the recording medium, by relating the layout information to the identification information.

20. An image management method comprising the steps of:
reading the images and the identification information from the recording medium in which the images and the identification information have been recorded according to the image recording method of claim 18;
storing the images read from the recording medium, by relating the images to the identification information;
reading the identification information from the communication device of the photo album;
searching for the images corresponding to the identification information; and
playing back the images found through the search.

21. An image management method comprising the steps of:
reading the images, the identification information, and the layout information from the recording medium in which the images, the identification information, and the layout information have been recorded according to the image recording method of claim 19;
storing the images and the layout information read from the recording medium, by relating the images and the layout information to the identification information;
reading the identification information from the communication device of the photo album;
searching for the images and the layout information corresponding to the identification information; and
playing back the images found through the search by laying out the images according to the layout information found through the search.

22. A computer-readable recording medium storing a program causing a computer to execute an image recording method, the program comprising the procedures of:
reading identification information from a photo album containing print storage units wherein index prints having a plurality of images laid out in a predetermined layout can be stored and a recording medium storage unit wherein a recording medium storing the images is stored, the photo album having a communication device storing the identification information identifying the photo album; and
recording all the images laid out in the index prints in the recording medium, by relating the images to the identification information.

23. A computer-readable recording medium storing a program causing a computer to execute an image management method, the program comprising the procedures of:
reading the images and the identification information from the recording medium in which the images and the identification information have been recorded according to the image recording method of claim 18;
storing the images read from the recording medium, by relating the images to the identification information;
reading the identification information from the communication device of the photo album;
searching for the images corresponding to the identification information; and
playing back the images found through the search.

24. A computer-readable recording medium storing a program causing a computer to execute an image management method, the program comprising the procedures of:
reading the images, the identification information, and the layout information from the recording medium in which the images, the identification information, and the layout information have been recorded according to the image recording method of claim 19;
storing the images and the layout information read from the recording medium, by relating the images and the layout information to the identification information;
reading the identification information from the communication device of the photo album;
searching for the images and the layout information corresponding to the identification information; and
playing back the images found through the search by laying out the images according to the layout information found through the search.
